(19) United States
(12) Patent Application Publication
(10) Pub. No.: US 2014/0294091 A1
(43) Pub. Date: Oct. 2, 2014

(54) METHOD OF AND APPARATUS FOR COMPRESSION ENCODING A PICTURE IN A PICTURE SEQUENCE

(71) Applicants: Alois Martin Bock, Eastleigh (GB); Tarek Amara, Southampton (GB); David Clewer, Southampton (GB)

(72) Inventors: Alois Martin Bock, Eastleigh (GB); Tarek Amara, Southampton (GB); David Clewer, Southampton (GB)

(73) Assignee: TELEFONAKTIEBOLAGET L M ERICSSON (PUBL), Stockholm (SE)

(21) Appl. No.: 14/357,885

(22) PCT Filed: Nov. 14, 2011
(86) PCT No.: PCT/EP2011/070063

§ 371 Date: May 13, 2014

(51) Int. Cl. H04N 19/146; H04N 19/176; H04N 19/119; H04N 19/46; H04N 19/86

(52) U.S. Cl. CPC H04N 19/00169; H04N 19/00545; H04N 19/00915; H04N 19/00072; H04N 19/00278
USPC 375/240.24

(57) ABSTRACT

The present invention relates to a method of and apparatus for compression encoding of a picture in a picture sequence. In particular, the invention relates to a method of and apparatus for compression encoding of a picture in a picture sequence so as to maintain a good picture quality while providing compression coding and decoding with low latency. The invention provides a method of compression encoding a picture in a picture sequence in which the pictures in the picture sequence are coded as prediction coded pictures with a single reference picture and have at least two macroblock sets. One set is a refresh set in which the macroblocks are intra-picture coded. The decoded compression coded picture information used for compression coding picture information is decoded without use of a de-blocking filter.

### TECHNICAL FIELD

The present invention relates to a method of and apparatus for compression encoding of a picture in a picture sequence. In particular, the invention relates to a method of and apparatus for compression encoding of a picture in a picture sequence intended to maintain a good picture quality while providing compression coding and decoding with low latency.

### BACKGROUND

In the Broadcast Video industry, video signals are compressed before being transferred across communication links in order to minimise the bandwidth required for the transfer. In some applications such as, for example, live sporting events, sports betting, and Digital Satellite News Gathering (DSNG) links with a two-way conversation between a journalist in the field and the news studio, for example, it may often be desirable to provide high quality trunk video services across communication links with low latency.

As will be known by a skilled person, video compression methods typically exploit spatial redundancy within a picture and temporal redundancy between the current picture and other pictures in the picture sequence in order to reduce the number of bits required to represent the picture at a particular quality level. However, some of the current compression methods use compression techniques that result in an increase in complexity and an increase in the latency in the compression encoding and compression decoding techniques.

A straightforward way to reduce end-to-end delay in video broadcast system is to remove reordering delay, by avoiding the use of Bi-directionally predicted frames (B frames). To achieve even lower delays, a smaller rate buffer can be used at the encoder. However, this reduces the effectiveness of the rate buffer in smoothing out the inherent variability in the relative bit cost of different frame types. Generally Intra-coded (I) pictures take significantly more bits to code than Predicted (P) pictures for the same video quality, simply because Intra-coded (I) pictures do not exploit redundancy by using temporal prediction from other pictures in the picture sequence.

Despite their high bit cost, Intra-coded (I) pictures are usually encoded periodically into the video stream to enable random access (channel change).A smaller rate buffer could be used at the encoder, and a smaller end-to-end delay could be achieved, if the requirement for Intra-coded (I) picture insertion were relaxed. Without Intra-coded (I) pictures, however, the receiver would have to lock into the stream at a random point, and at this random access point, the reference frames buffers between encoder and decoder would mismatch, causing noticeable block artefacts in the decoded picture.

In an Intra Refresh mode used in the MPEG2 compression coding scheme (ISO/IEC 13818), standardised by the International Organization for Standardization (ISO)/International Electrotechnical Commission (IEC) Moving Picture Experts Group (MPEG), a number of individual macroblocks in each predicted (P) picture are intra-coded, and the positions of the intra-coded macroblocks are different in successive pictures so that after a short sequence of pictures, all the macroblock positions have been Intra coded at least once. After a period of time, due to the repeated Intra macroblock refresh, the differences in the reference frames between the encoder and decoder references buffers tend to diminish to a point that becomes unnoticeable to the viewer.

The H.264/MPEG-4 AVC compression scheme standard developed by the ITU-T Video Coding Experts Group (VCEG) together with the International Organization for Standardization (ISO)/International Electrotechnical Commission (IEC) Moving Picture Experts Group (MPEG) are now widely available and had many features that enable greater compression efficiencies to be achieved compared with previous compression schemes.

The present invention seeks to alleviate at least some of the disadvantages of the prior art, and to provide a novel method of and apparatus for compression encoding a picture in a picture sequence.

### SUMMARY

In accordance with one aspect of the invention, there is provided a method of compression encoding a picture in a picture sequence. For each macroblock of a plurality of macroblocks of picture information in the picture, the method comprises a first step of determining whether the macroblock belongs to a refresh set for the picture. In a second step a first macroblock encoding processing or second macroblock encoding processing is selected for the macroblock, wherein the second macroblock encoding processing is selected for all macroblocks determined to be in the refresh set.

In a third step picture information of the macroblock is compression encoded according to the selected first macroblock encoding processing or second macroblock encoding processing to form compressed picture information, using decoded picture information that has been decoded from previously compressed picture information without application of deblocking, wherein decoded picture information from a previous reference picture in the picture sequence is used during first macroblock encoding processing and decoded picture information from the current picture is used during second macro block encoding processing. In a fourth step a de-blocking parameter indicating no de-blocking applied during compression decoding of compressed picture information; and reference picture parameter indicating use of a single reference picture in second macro block encoding processing are associated with compressed picture information of the picture.

In some embodiments, the position of the refresh set within the picture is changed in consecutive pictures of the picture sequence so that after a number of pictures all macroblockpositions have been compression coded using the second macro block encoding processing.

In some embodiments, the refresh set comprises a row of macroblocks. In other embodiments, the refresh set comprises every nth macroblock within a picture.

In some embodiments, the step of associating also includes the step of associating picture and sequence parameter sets with the compressed picture information.

In some embodiments, different scaling factors are used in the step of first macroblock encoding processing than are used in the step of second macroblock encoding processing such that the differences between the scaling factors increases with increasing horizontal and vertical transform coefficient.

In some embodiments the scaling factors are selected such that the difference between the scaling factors used in the first macroblock encoding process and the second macroblock encoding process are within the ranges bounded by the upper and lower bounds defined by FIGS. 10 and 11a-11d.

In some embodiments scaling lists for the scaling factors are associated with the compressed picture information.

In accordance with a second aspect of the invention there is provided an apparatus for compression encoding a picture in a picture sequence comprising. The apparatus has an encoder, coupled to receive macro block picture information and to form output compressed picture information. The encoder comprises a first macroblock encoder, arranged to compression encode picture information of a macro block using decoded picture information from one previous reference picture in the picture sequence to form compressed picture information. The encoder also comprises a second macroblock encoder, arranged to compression encode picture information of a macro block using decoded picture information from the current picture to form compressed picture information. The encoder also comprises a picture store, for storing picture information that has been compression decoded from the output compressed picture information without application of de-blocking, the picture store being coupled to supply decoded picture information to the first macroblock encoder and to the second macroblock encoder. The apparatus also has an encoder controller, for controlling the operation of the encoder. The encoder controller comprises a selector element arranged to couple each of the plurality of macroblocks in a picture to the first macroblock encoder or to the second macroblock encoder for compression encoding, the selector element being operable to select the second macroblock encoder for all macroblocks in a refresh set for the picture. The encoder controller also comprises a parameter association element operable to associate with compressed picture information of the picture: reference picture parameter indicating use of a single reference picture by the second macroblock encoder; and de-blocking parameter indicating no de-blocking applied during compression decoding of compressed picture information stored in the picture store.

In some embodiments the apparatus also comprises a set determination element for determining whether a macroblock is in a refresh set for that picture.

### BRIEF DESCRIPTION OF THE DRAWINGS

The invention will now be described by way of example with reference to the accompanying drawings:

FIG. 1 is a schematic drawing showing a typical video signal transfer system;

FIG. 2 is a schematic diagram illustrating the relationship between the parameter sets in a compression coder and a corresponding compression decoder;

FIG. 3 shows a schematic diagram of relevant elements of a compression encoder in accordance with an embodiment of the invention;

FIG. 4 is a flow chart showing steps of a method in accordance with the exemplary embodiment that may be implemented by the exemplary compression coder shown in FIG. 3;

FIG. 5 shows a first arrangement of macroblocks in a refresh set

FIG. 6 shows a second arrangement of macroblocks in a refresh set;

FIG. 7 shows a third arrangement of macroblocks in a refresh set;

FIG. 8 shows a fourth arrangement of macroblocks in a refresh set;

FIG. 9 shows a fifth arrangement of macroblocks in a refresh set;

FIG. 10 is a first table showing ranges of differences between Intra and Inter Scaling Lists settings; and

FIGS. 11a-11d form a second table showing ranges of differences between Intra and Inter Scaling Lists settings.

In embodiments of the invention a method of and apparatus for encoding a picture in a picture sequence is provided that enables low encoding delay to be achieved together with a high picture quality. In order to achieve the low encoding delay only forward-predicted P pictures having a single reference picture are used.

In each picture, the macroblocks within a refresh set are forced to be intra-picture compression coded so that any divergence between encoder and decoder reference frame buffers, which may be caused for example by a cut in the video picture sequence, is quickly minimised.

In embodiments of the invention, the high visual quality of the video is maintained and the visual effect of the Intra refresh pattern is minimized by selection of appropriate picture referencing and deblocking filter parameters. In particular, only a single reference picture is used for each of the forward predicted (P) pictures of the picture sequence and no de-blocking filtering is carried out in decoding the compressed picture information.

In addition, random access into the stream is enabled by periodically sending the Picture Parameter Set and Sequence Parameter Sets, which provide the compression decoder with information relevant to individual pictures, and to all pictures in a picture sequence respectively.

In some embodiments of the invention, the visual effect of the Intra refresh pattern may minimized by selection of appropriate quantization scaling matrices and parameters.

The invention may be implemented using the H.264/MPEG-4 AVC compression standard developed by the ITU-T Video Coding Experts Group (VCEG) together with the International Organization for Standardization (ISO)/International Electrotechnical Commission (IEC) Moving Picture Experts Group (MPEG).

The use of multiple reference pictures during compression coding of a forward-predicted P picture, and the use of deblocking filtering when decoding the compressed picture information were introduced in the H.264/MPEG-4 AVC compression standard to improve compression efficiencies and picture quality.

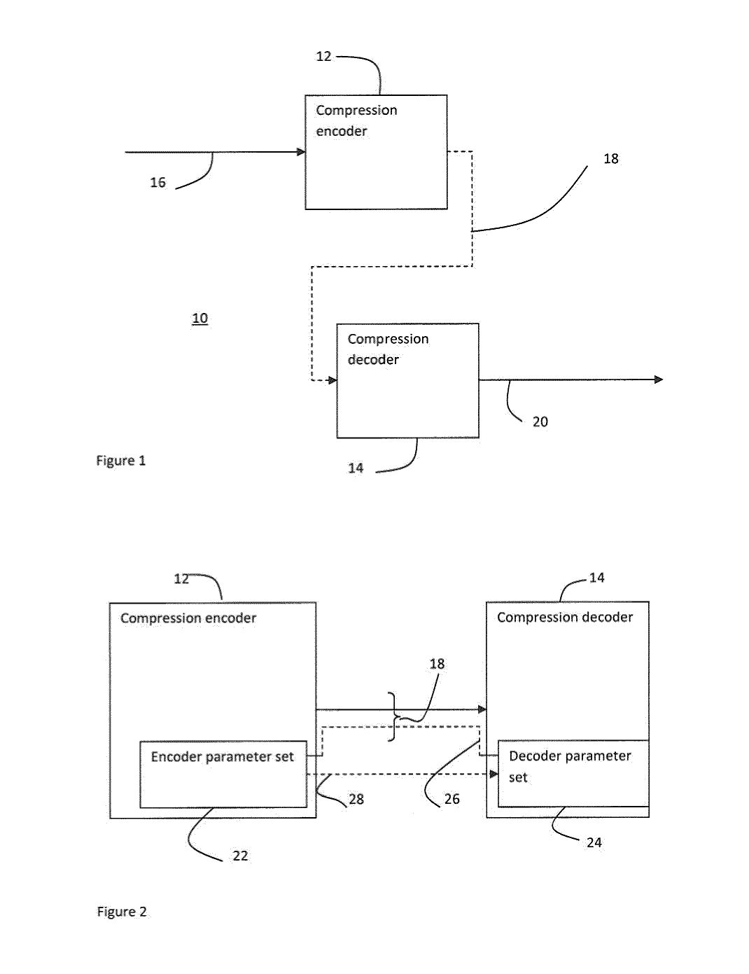

Exemplary embodiments will now be explained with reference to the accompanying drawings. FIG. 1 is a schematic drawing showing a typical video transfer system 10. The video transfer system 10 comprises a compression encoder 12 and a compression decoder 14. The compression encoder 12 receives a video signal 16 and compression encodes the sequence of pictures of the video signal 16 to produce a compressed bitstream 18. The compressed bitstream 18 can then be transferred across a communication channel until it is received at the compression decoder 14. The compression decoder compression decodes the received compressed bit stream 18 to obtain a compression decoded video signal 20.

FIG. 2 is a schematic diagram illustrating the relationship between the parameter sets in a compression coder and a compression decoder such as the compression coder 12 and the compression decoder 14. It is assumed that the video compression encoder 12 is operating under a compression standard and therefore generates a compressed bit stream 18 that complies with the standard. The compression decoder 14 is compliant with the compression standard and therefore the compression decoder 14 is able to decode the compressed bit stream 18. In the exemplary embodiment, it is assumed that the video compression encoder 12 is operating under the H.264/MPEG-4 AVC compression standard and that the compression decoder 14 is compliant with the H.264/MPEG-4 AVC compression standard.

As will be apparent to a skilled person the compression encoder 12 is provided with an encoder parameter set 22 and the compression encoder 12 carries out a compression encoding of the video signal in accordance with the encoder parameter set 22. Similarly, as will be apparent to a skilled person, the compression decoder 14 is provided with a decoder parameter set 24 and the compression decoder 14 carries out a compression decoding of the compressed bit stream in accordance with the decoder parameter set 24.

In order for the compression decoder 14 to be able to successfully decode the bitstream 18 received from the compression encoder 12, the decoder parameter set 24 must correspond with the encoder parameter set 22. Parameters within the encoder parameter set 22 must be associated with the compressed picture information produced by the compression encoder 12. Most usually, encoder parameters 26 in the encoder parameter set 22 are associated with the compressed picture information within the header information in the bitstream 18 or within a Sequence Parameter Set or a Picture Parameter Set associated with the compressed picture information including the motion vectors to form the compressed bit stream 18, as will be familiar to a skilled person. However, this is not necessary, and in some embodiments it may be possible for the encoder parameters to be associated with the compressed picture information in some other way for transfer 28 to the compression decoder 14 to use as the parameter decoder set 24. However, in the exemplary embodiment it is assumed that parameters relevant to the operation of the decoder are sent from the compression encoder 12 to the compression decoder 14 in header information in the compressed bit stream or within a Sequence Parameter Set or a Picture Parameter Set.

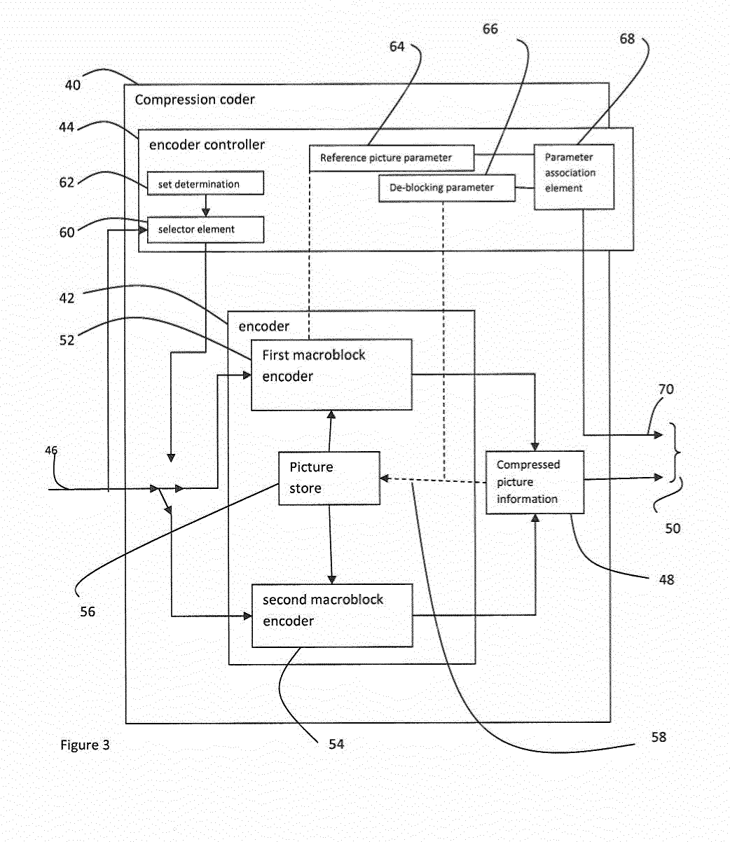

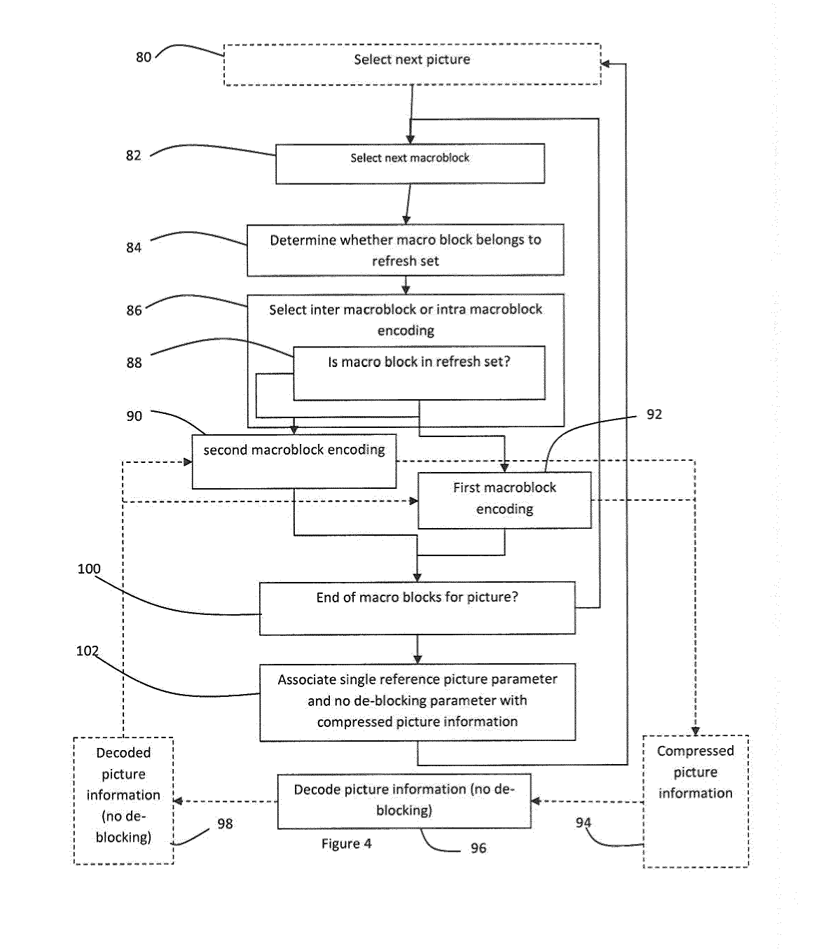

An exemplary embodiment will now be explained with reference to FIGS. 3 and 4. FIG. 3 shows a schematic diagram of relevant elements of a compression encoder in accordance with an embodiment of the invention. In the exemplary embodiment the compression coder is a compression coder compliant with the H.264/MPEG-4 AVC standard. FIG. 4 is a flow chart showing steps of a method in accordance with the exemplary embodiment that may be implemented by the exemplary compression coder shown in FIG. 3.

As shown in FIG. 3, a compression coder 40 comprises an encoder 42 and an encoder controller 44. The elements of the compression coder 40 have been simplified in the exemplary embodiment for the sake of clarity, as will be apparent to a skilled person.

The encoder 42 is arranged to receive picture information 46 of a picture, to compression encode the picture information 46 to produce compressed picture information 48. The compressed picture information 48 forms part of the compressed bit stream 50 output by the compression coder 40, as will be known by a skilled person.

The encoder 42 is provided with a first macroblock encoder 52, operable to compression encode received picture information 46 using a first macroblock encoding process, and a second macroblock encoder 54, operable to compression encode received picture information 46 using a second macroblock encoding process, as will be explained in more detail with reference to FIG. 4. Both the first macroblock encoder 52 and the second macroblock encoder 54 are coupled to a picture store 56, in which is stored picture information that has been compression decoded from previous compressed picture information 48 as shown by the dashed line 58.

In this exemplary embodiment, the first macroblock encoding process used by the first macroblock encoder 52 is an inter-picture compression process using decoded picture information from a single previous reference picture in the picture store 56. In the exemplary embodiment, the second macroblock encoding process used by the second macroblock encoder 54 is an intra picture compression process using decoded picture information from the current picture in the picture store 56.

The separation of the encoder elements into a first macroblock encoder 52 and the second macroblock encoder 54 in FIG. 3 is intended to aid the description of the exemplary embodiment. As will be known to a skilled person, elements of the first macroblock encoder 52 and the second macroblock encoder 54 are similar and are often largely combined in practical implementations of a compression encoder.

The encoder controller 44 controls the operation of the encoder 42 to compression encode the received picture information 46. In particular, the encoder controller 44 is provided with a selector element 60, which operates to select whether each macroblock of picture information 46 undergoes a first macroblock encoding process in the first macroblock encoder 52 or undergoes a second macroblock encoding process in the second macroblock encoder 54. The encoder controller 44 is also provided with a refresh set determination element 62 coupled to the selector element 60, which is arranged to determine whether a macroblock in a picture is part of a refresh set for that picture.

The encoder controller 44 is provided with a number of parameters for controlling the operation of the encoder 42 during the compression encoding of a picture in a picture sequence. FIG. 3 shows a reference picture parameter 64 and a de-blocking parameter 66 that are relevant to the operation of the exemplary embodiment. The encoder controller 44 is also provided with a parameter association element 68, which is operable to associate the reference picture parameter 64 and the de-blocking parameter 66 with the compressed picture information 48. In the exemplary embodiment, the reference picture parameter 64 and the de-blocking parameter 66 are associated with the compressed picture information 48 by being included as header information 70 as part of the compressed bit stream 50.

The compression coder 40 may be implemented in different ways as will be apparent to a skilled person. In particular, the compression coder may be implemented in software or by dedicated hardware or by suitable arranged general hardware, as selected by a skilled person.

An exemplary method of operation of the compression encoder 40 shown in FIG. 3 will now be described with reference to FIG. 4.

In a first step 80 shown in FIG. 4, a new picture is selected for compression coding.

As will be known to a skilled person, the picture information of pixels in the pictures to be compressed is divided into macroblocks, and compression coding is carried out on a macroblock by macroblock basis. Thus in step 82 the next macroblock to be compression coded is selected.

In step 84, it is determined whether the macro block belongs to a refresh set for this picture. In the exemplary compression coder 40 shown in FIG. 3, this step may be carried out by refresh set determination element 62.

In step 86, inter macroblock compression coding or intra macroblock compression coding is selected for the macroblock. In the exemplary compression coder 40 shown in FIG. 3, this step may be carried out by the selector element 60 by controlling whether the current macroblock is applied to the first macroblock encoder 52 for compression encoding, or is applied to the second macroblock encoder 54.

If the macroblock is determined to be in the refresh set for that picture, intra macroblock encoding processing in step 90 is selected by the selector element 60 in step 88-y and the macroblock is applied by the selector element 62 to second macroblock encoder 54. Thus intra macroblock compression coding is always selected for macroblocks that are in the refresh set.

If the macroblock is determined not to be in the refresh set for that picture in step 88-n, in the exemplary embodiment the selector element 60 selects intra macroblock encoding processing in step 90 or inter macroblock encoding in step 92. Typically the selector element 60 will select the encoding processing that will result in the fewest number of bits. The macroblock is applied by the selector element 60 to second macroblock encoder 54 or to first macroblock encoder 52 in accordance with the type of coding selected.

As will be appreciated by a skilled person, both the intra macroblock coding in step 90 and the inter-macroblock coding in step 92 produce compressed picture information 94, which is decoded in step 96 as part of the encoding process to form decoded picture information 98. The compressed picture information is compression decoded without the use of a de-blocking filter in step 96. The decoded picture information 98 is used in the intra macroblock encoding processing in step 90 or inter macroblock encoding in step 92.

The intra macroblock encoding step 90 uses decoded picture information that has been decoded without the use of deblocking from previous compression coded macroblocks within the current picture, as will be known by a skilled person.

The inter macroblock encoding step 92 uses decoded picture information that has been decoded without the use of deblocking from compression coded macroblocks of a single reference picture occurring prior to the current picture in the picture sequence.

Once the macroblock has been processed, it is determined whether all macroblocks in the picture have been compression coded in step 100. If not all macroblocks have been processed, step 100-n, the process returns to step 82 to start the processing of the next macroblock in the current picture.

Once all the macroblocks in a picture have been processed, step 100-y, in step 102 the single reference picture parameter and the de-blocking parameter are associated with the compressed picture information. The parameter association element 68 shown in FIG. 3 carries out this step. The parameters may be associated with the compressed picture information in a number of ways. For example the parameters can be included in picture headers or slice headers in the compressed bit stream.

Thus it can be seen that in order to achieve high visual quality, very low delay encoding of pictures in the exemplary embodiment that conforms to the H.264/AVC standard, the following steps are employed:

Firstly, only P picture types (apart from the very first picture, which is an IDR) are used. Each picture is coded with at least two sets of macroblocks. At least one set of macroblocks is a refresh set and the macroblocks within the refresh set are intra picture compression coded. At least one set of macroblocks is an inter-picture compression coded set. The number of reference pictures for each picture is set to 1. This may be achieved in some embodiments by setting the parameter num_ref_idx_{—}10_active_minus 1 to 0 in a slice Header.

In the H.264/AVC compression standard the ability to increase the number of reference pictures from which picture information is taken during inter-frame compression coding generally increases the compression efficiency and therefore improves the quality for a given bit rate. However, as a counter-intuitive step, in accordance with embodiments of this invention only one reference picture is used for the inter picture compression coding.

This is because once certain regions of the picture have been intra picture compression coded, it would be beneficial for the purposes of encoder-decoder Decoded Picture Buffer convergence if those Intra compression coded regions are used as a reference for future prediction. By restricting the choice of reference pixels to predict from, in particular in slow moving or still scenes, this makes it more likely that Intra coded areas are used as a basis for prediction in the frame immediately following the current one.

As will be known to a skilled person, an in-loop deblocking filter is provided in the H.264/AVC compression standard in order to reduce the visual impact of block edges. Embodiments of the invention require that the in-loop deblocking filter is not used in the encoder, and that this is signalled to the compression decoder, for example by setting disable_deblocking_filter_idc to 1 in the Slice Header for example, in order to prevent any neighbouring Inter-picture compression coded macroblocks from affecting the spatial predictions of Intra picture compression coded macroblocks. This also benefits any naturally occurring Intra-picture coded macroblocks in a picture, not just the Intra picture compression coded macroblocks forced by the Intra Refresh scheme.

The use of the de-blocking filter creates dependencies between neighbouring macroblocks which is undesirable when an Inter-coded macroblock is adjacent to an Intra-coded macroblock. This is because, once a decoder starts to decode the stream, the contents of the reference frame buffer known as the Decoded Picture Buffer in the H.264/MPEG-4 AVC compression scheme will be different in the decoder compared with the encoder, and hence any inter picture predictions using picture information in the Decoded Picture Buffer as references will likely be visually poor. The deblocking filter is disabled to prevent the visually impaired Inter picture prediction from affecting the Intra picture prediction coded macroblock.

In successive pictures in the exemplary embodiment, the refresh set comprises macroblocks at different positions within the picture, so that after a few pictures all macroblock positions would have been in a refresh set in at least one of the pictures and have therefore been intra coded at least once.

The refresh set of macroblocks within a picture may be arranged in different ways in different embodiments. In different embodiments the macroblocks in the refresh set that are to be intra coded can be arranged within one or more rows of the picture, or can use a checkerboard pattern or other pattern as selected by a skilled person. In some embodiments, in each picture a certain number of macroblocks of the refresh set are arranged in at least one refresh slice. The picture may be encoded with the refresh slice for each picture being one or more rows of macroblocks.

In the exemplary embodiment the refresh set containing the forced intra coded macroblocks is defined to be a refresh slice containing at least one row of macroblocks in a picture. In some embodiments, successive refresh slices may be selected for consecutive pictures in the picture sequence.

However, instead of an Intra row refresh pattern, a checkerboard pattern of macroblocks of Intra refresh can be also used in some embodiments, as described below.

Let:
IntraMacroblocksPerPicture=the number of intra macroblocks per picture. This could be equal to the number of macroblocks per row.
IntraRefreshFrameDistance=the distance between two intra macroblock in the picture (using the raster scan order).
NumMacroblocksPerPicture=PictureWidth*PictureHeight/256
IntraRefreshFrameDistance=NumMacroblocksPerPicture/IntraMacroblocksPerPicture

IntraRefreshFrameDistance also corresponds with the number of encoded pictures after which all macroblock positions have been coded using intra picture prediction mode at least once.

A random pattern is created to specify which macroblock positions in each picture are in the refresh set for that picture, and that therefore which macroblocks should be forced to be intra macroblock coded

A table of macroblock indices of size IntraRefreshFrameDistance is first initialized to −1.

Then the order in which each macroblock is coded as intra prediction coded is randomly generated: so for every index of the table an order will be given from 0 to (IntraRefreshFrameDistance-1)

After the pattern is specified, during the encoding process, every macroblock position needs to be checked in the pattern table IntraMacroblockIdx to determine whether it needs to be coded in intra mode.

In an illustrative embodiment, if
pictureWidth=96 pixels (6 macroblocks) and pictureHeight=96 pixels (6 macroblocks)

The number of intra-coded macroblocks per picture is set at 9, so
IntraMacroblocksPerPicture=9
And so IntraRefreshFrameDistance=6*6/9
   =4.

The IntraMacroblockIdx index could be generated as follows: The IntraMacroblockIdx index values are randomly generated for every index and are integer values from 0 to IntraRefreshFrameDistance-1. For example:

| IntraMacroblockIdx | index value |
|---|---|
| 0 | 1 |
| 1 | 0 |
| 2 | 3 |
| 3 | 2 |

The interpretation of the IntraMacroblockIdx index table is as follows:
for i=0−IntraMacroblocksPerPicture−1):
Frame 0, macroblocks 1+i*IntraRefreshFrameDistance will be intra coded.
Frame 1, macroblock 0+i*IntraRefreshFrameDistance will be intra coded.
Frame 2, macroblock 3+i*IntraRefreshFrameDistance will be intra coded.
Fame 3, where macroblock 2+i*IntraRefreshFrameDistance will be intra coded.

And thereafter, the pattern repeats itself

FIG. 5 shows a first arrangement of macroblocks in a refresh set in which the macroblocks in a refresh slice for this picture are shown in grey.

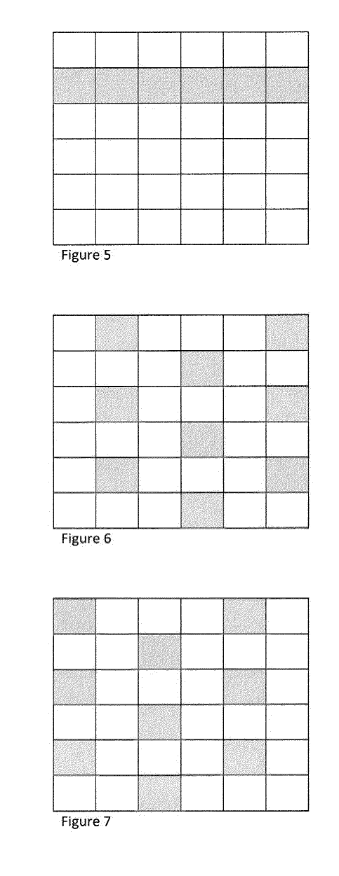

In contrast FIGS. 6-9 show arrangement of macroblocks in a refresh set of the picture in successive pictures in the picture sequence. Again, the macroblocks in the refresh set for each picture are shown in grey.

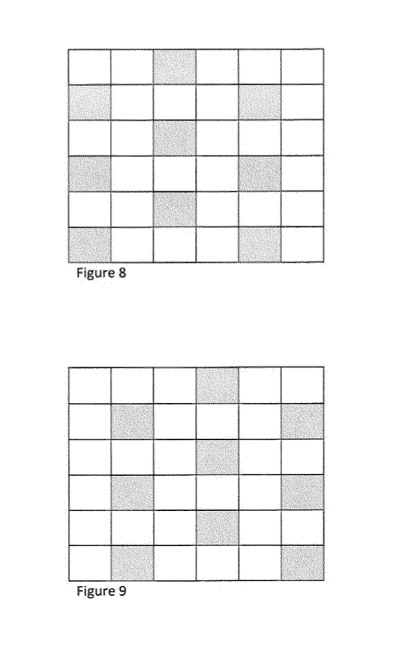

FIG. 6 shows the Frame 1 intra coded macroblock positions for a first index value in grey. FIG. 7 shows Frame 2 intra coded macroblocks positions for a second index value in grey. FIG. 8 shows Frame 3 intra coded macroblocks positions for a third index value in grey. FIG. 9 shows Frame 3 intra coded macroblocks positions for a fourth index value in grey.

It is noted that use of the refresh slice and the checkerboard intra refresh method as described above also guarantees that after a given number of pictures all macroblock positions within a picture would have been encoded with an intra mode macroblock at least once.

In some embodiments multiple IntraMacroblockIdx index may be created and used within the same picture to avoid the creation of any distinguishable pattern, and these patterns could be used simultaneously within the same picture.

Appropriate Sequence and Picture Parameter Sets are sent periodically, typically every second, to allow random access decoding of the stream.

As will be appreciated by a skilled person, the pictures in the picture sequence may be compression coded as fields or as frames. If a frame is coded as two fields, the top field will reference the top field of a previous frame. The bottom field of the frame will reference the bottom field of a previous frame. If the frame is coded as a frame, it will reference a previous frame.

In some embodiments, scaling lists may be used to require different quantisation and scaling to be used for inter coded macroblocks and intra-coded macroblocks. In some embodiments, therefore, an appropriate level and profile of the H.264/AVC standard are used that allow scaling lists to be signalled in the compressed bit stream and used at the decoder. For example, at present scaling lists are available for High, High10, High422 Profile or High444 Profile of the H.264/AVC standard.

The H.264/AVC quantization Scaling Lists in the exemplary embodiments are configured such that the difference in scaling parameters between Intra and Inter coded macroblocks increases with increasing horizontal and vertical transform coefficient position.

The use of Scaling Lists in H.264 can be defined in the Sequence Parameter Set, the Picture Parameter Set, or both. The Scaling Lists are used in such a way that the boundary between Intra-coded macroblocks and Inter-coded macroblocks within the picture is not obviously visible to the viewer.

In some embodiments Scaling Lists in the bitstream, configured such that the difference in scaling parameters between Intra and Inter coded macroblocks increases with increasing horizontal and vertical transform coefficient position.

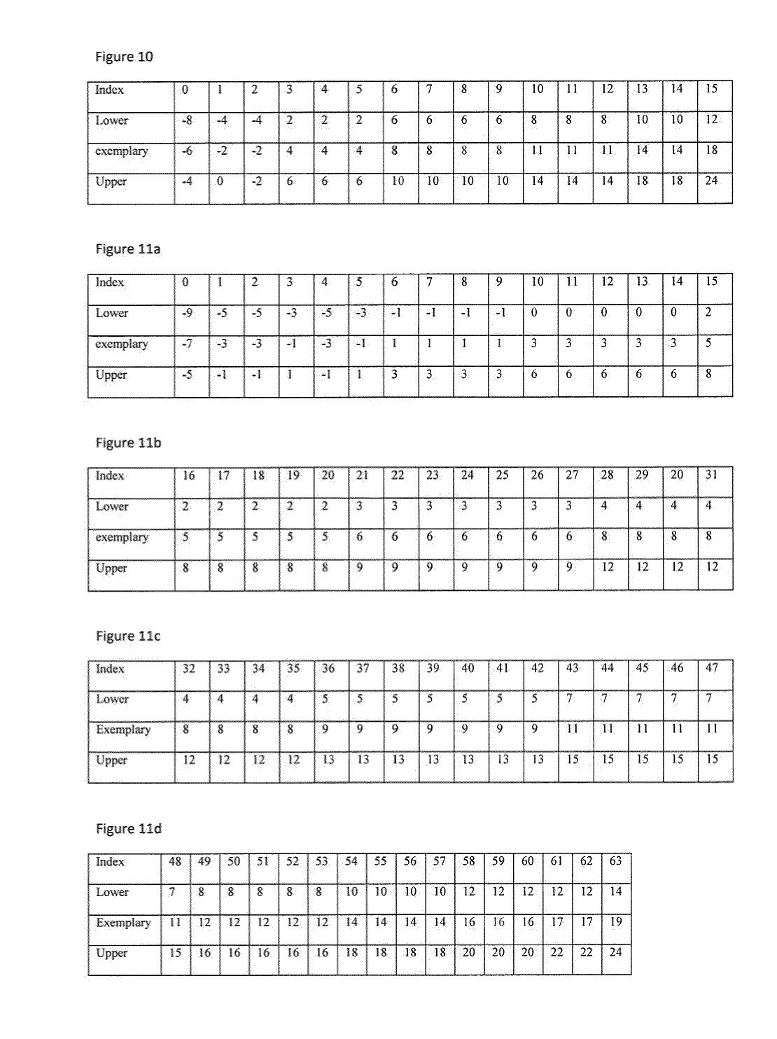

FIG. 10 is a table showing range of differences between Intra and Inter Scaling Lists settings for scaling list indexes 0, 1, 2 for 4×4 intra coded block transform for a upper bound and lower bound range of values and a range of values in an exemplary embodiment.

FIGS. 11a-11d collectively form a table showing range of differences between Intra and Inter Scaling Lists settings for scaling list index 7 for a 8×8 inter coded block for a upper bound and lower bound range of values and a range of values in an exemplary embodiment

Note that the Scaling List values allowed in the H.264/AVC compression standard range from 1 to 255. FIGS. 10 and 11a-11d only specify differences between Intra and Inter Scaling Lists, therefore it is up to the user to ensure that this results in valid Scaling List values according to the H.264/AVC compression standard in the exemplary embodiment.

Although FIGS. 10 and 11a-11d show the settings for Scaling List differences between Inter and Intra coded macroblocks in accordance with the exemplary embodiment, the skilled person will understand that there may also be an allowable variation in these difference values which will still give some noticeable benefit to visual quality. These difference ranges are shown in FIGS. 9 and 10a-10d below, given as two figures (lower bound, upper bound) for each coefficient position (or idx).

Therefore it will be appreciated by a skilled person that that in embodiments of the invention the divergence between encoder and decoder reference frame buffers is quickly minimised by using Intra refresh encoding, either using a row or checkerboard pattern for the refresh set of macroblock positions in each picture. By encoding only predicatively coded (P) pictures and using multiple sets of macroblocks including a refresh set per picture, very low delay encoding can be achieved. The combination of the specified parameters ensures the high visual quality of the video is maintained at a low encoding delay. In some embodiments the visual effect of the Intra refresh pattern may minimized by selection of appropriate quantization scaling matrices and parameters, and referencing and deblocking filter parameters. The combination of parameters used is not obvious to one skilled in the art, and as such, produce a novel solution.

1. A method of compression encoding a picture in a picture sequence comprising, for each macroblock of a plurality of macroblocks of picture information in the picture, the steps of:
determining whether the macroblock belongs to a refresh set for the picture;
selecting first macroblock encoding processing or second macroblock encoding processing for the macroblock, wherein the second macroblock encoding processing is selected for all macroblocks determined to be in the refresh set;
compression encoding picture information of the macroblock according to the selected first macroblock encoding processing or second macroblock encoding processing to form compressed picture information, using decoded picture information that has been decoded from previously compressed picture information without application of deblocking, wherein decoded picture information from a previous reference picture in the picture sequence is used during first macroblock encoding processing and decoded picture information from the current picture is used during second macro block encoding processing; and
associating with compressed picture information of the picture: a de-blocking parameter indicating no de-blocking applied during compression decoding of compressed picture information; and reference picture parameter indicating use of a single reference picture in second macro block encoding processing.

2. The method as claimed in claim 1, wherein the position of the refresh set within the picture is changed in consecutive pictures of the picture sequence so that after a number of pictures all macroblock positions have been compression coded using the second macro block encoding processing.

3. The method as claimed in claim 1, wherein the refresh set comprises a refresh slice of macroblocks.

4. The method as claimed in claim 1, wherein the refresh set comprises every nth macroblock within a picture.

5. The method as claimed in claim 1, wherein the step of associating also includes the step of associating picture and sequence parameter sets with the compressed picture information.

6. The method as claimed in claim 1, wherein different scaling factors are used in the step of first macroblock encoding processing than are used in the step of second macroblock encoding processing such that the differences between the scaling factors increases with increasing horizontal and vertical transform coefficient.

7. The method as claimed in claim 6, wherein scaling lists are selected such that the difference between the scaling factors used in the first macroblock encoding process and the second macroblock encoding process are within the ranges bounded by the upper and lower bounds defined by FIGS. 10 and 11a-11d.

8. The method as claimed in claim 6, further comprising the step of associating scaling lists for the scaling factors with the compressed picture information.

9. An apparatus for compression encoding a picture in a picture sequence comprising:
an encoder, coupled to receive macro block picture information and to form output compressed picture information, comprising
a first macroblock encoder, arranged to compression encode picture information of a macro block using decoded picture information from one previous reference picture in the picture sequence to form compressed picture information;
a second macroblock encoder, arranged to compression encode picture information of a macro block using decoded picture information from the current picture to form compressed picture information; and
a picture store, for storing picture information that has been compression decoded from the output compressed picture information without application of de-blocking, the picture store being coupled to supply decoded picture information to the first macroblock encoder and to the second macroblock encoder; and
an encoder controller, for controlling the operation of the encoder, comprising:
a selector element arranged to couple each of the plurality of macroblocks in a picture to the first macroblock encoder or to the second macroblock encoder for compression encoding, the selector element being operable to select the second macroblock encoder for all macroblocks in a refresh set for the picture; and
a parameter association element operable to associate with compressed picture information of the picture: reference picture parameter indicating use of a single reference picture by the second macroblock encoder; and de-blocking parameter indicating no de-blocking applied during compression decoding of compressed picture information stored in the picture store.

10. The apparatus as claimed in claim 9, further comprising a refresh set determination element for determining whether a macroblock is in a refresh set for that picture.

11. The apparatus as claimed in claim 10, wherein the refresh set is a slice of macroblocks, and the refresh set determination element is operable to determine whether a macroblock is in a refresh set for the picture.
